(19) United States
(12) Patent Application Publication
(10) Pub. No.: US 2019/0291362 A1
(43) Pub. Date: Sep. 26, 2019

(54) DEVICE AND METHOD FOR PRODUCING A STRUCTURAL THERMOPLASTIC PART

(71) Applicant: Stelia Aerospace, Rochefort (FR)

(72) Inventor: Pierre Magnin, Balma (FR)

(21) Appl. No.: 16/359,074

(22) Filed: Mar. 20, 2019

(30) Foreign Application Priority Data
Mar. 21, 2018 (FR) 1852432

(51) Int. Cl. B29C 70/42

(52) U.S. Cl. CPC B29C 70/42; B29K 2307/04

(57) ABSTRACT

Structural thermoplastic part production device, intended to be integrated to a primary structure of an aeroplane, said structural part being formed from a draft part comprising reinforcing fibres embedded in a thermoplastic matrix, production device comprising a member for supporting a draft part, at least one heating member, at least one cooling member, at least one main compression member configured to compress the local portion of the draft part against the support member so as to decrease the porosity thereof and a system for moving the heating member, the compression member and the cooling member so as to stiffen each local portion of the draft part successively.

### TECHNICAL FIELD

The present invention relates to the field of producing aeronautic parts and more specifically relates to a device for producing large thermoplastic parts intended to form the structure of an aeroplane.

By large, this means one of the dimensions of the aeronautic part is greater than 1 m.

In a known manner, an aeroplane, or airplane, comprises a primary structure by which the mechanical forces transit, and a secondary structure mounted on the primary structure. In this regard, the primary structure in particular comprises the fuselage, delimiting the body of the aeroplane and defining the structural casing thereof, the airfoil, comprising the two wings, making it possible to ensure the lift of the aeroplane in flight, and the feathering placed at the rear of the aeroplane and making it possible to ensure the stability thereof.

The primary structure in particular comprises several side members. According to the state of the art, a side member has a U-shaped cross-section so as to have an increased rigidity. In a known manner, a side member made of a metal material, for example, made of aluminium. However, a metal material has the disadvantage of being heavy, also the side members are today generally made of a composite material.

In a known manner, a side member made of composite material is produced by impregnating reinforcing fibres in a thermosetting matrix. Such a thermosetting matrix is frozen by polymerisation, i.e. by means of a chemical reaction during which the matrix passes from the liquid or viscous state to the solid state under the effect of heat. When the thermosetting matrix is hot, it is moulded in order to obtain the desired shape, as is the case, for example, from U-shaped side members, for which it is necessary to curve the two side branches. For this, the thermosetting composite part is moulded, for example, by thermocompression in an autoclave. In a known manner, an autoclave is a hermetic enclosure wherein the pressure and the temperature can be controlled and increased so as to press the composite material between a mould and a backing mould while heating the assembly, in order to give the produced part the final shape thereof. However, such an autoclave has limited dimensions, which does not make it possible to produce large parts, like for example, side members of an aeroplane wing, which must be held in a confined enclosure. In addition, such composite parts take a long time to produce. The polymerisation is done by heating at between 100 and 200° C. for a duration of several hours. The production rate is therefore low.

Also, there is a desire to replace the thermosetting matrix composite parts with thermoplastic matrix composite parts. The cycle for producing such a part is shorter, but has the disadvantage of having to be heated at very high temperatures, which could go up to 410° C. in order to consolidate the composite part.

To form such a part, the reinforcing fibres are embedded in the thermoplastic matrix, then the assembly is heated and positioned between two moulds to be shaped, for example, in a press, applying a significant pressure on all of the moulds by means of one or more hydraulic actuators. However, such a production method has the disadvantage of requiring a perfect alignment of the two moulds positioned opposite one another, in order to limit the risks of deforming the part, as well as an equal pressure over the whole length of the moulds, so as to compress all of the mould, which is complex to implement for the production of large parts. Also, the production methods according to the prior art does not make it possible to produce large parts, like for example, a one-piece side member.

According to the state of the art, to date there is no alternative method to the autoclave making it possible for the quicker production of parts made of thermoplastic composite material. Only one very large autoclave would make it possible to produce large parts, such an autoclave is very expensive. Producing one single holding of long parts makes it possible to limit the junctions due to the assembly of several parts thus making it possible to limit the presence of fragile zones in the primary structure of an aeroplane.

One of the aims of the present invention is to propose a device and a method for producing single, quick and effective thermoplastic parts, making it possible to produce long parts, of one single holding, without requiring the use of an autoclave.

### SUMMARY

To this end, the invention relates to a device for producing a structural thermoplastic part, intended to be integrated to a primary structure of an aeroplane, or airplane, said structural part being formed from a draft part comprising reinforcing fibres embedded in a thermoplastic matrix, production device comprising:
a member for supporting a draft part, the support member extending along a longitudinal axis X,
at least one heating member configured to heat a local portion of the draft part at a temperature making it possible to make the thermoplastic matrix of the draft part melt,
at least one cooling member configured to cool the local portion of the draft part at a temperature making it possible to solidify the thermoplastic matrix of the draft part,
at least one main compression member configured to compress the local portion of the draft part against the support member so as to decrease the porosity thereof, the main compression member being situated between the heating member and the cooling member, and
a system for moving, from upstream to downstream, along the longitudinal axis of the heating member, the compression member and the cooling member relative to the support member so as to consolidate each local portion of the draft part successively.

According to the invention, the production device makes it possible to consecutively treat each longitudinal portion of the draft part to obtain a finished part. Contrarily to the prior art which involved resorting to larger equipment than that of the part to be formed, the production device makes it possible for a local treatment, and not an overall treatment. This advantageously makes it possible to produce structural large parts. Furthermore, such a device for producing thermoplastic matrix structural parts enables increased production rates, which were not achievable for thermosetting matrix structural parts. Using mobile heating, compression and cooling members makes it possible to locally decrease the porosity of a longitudinal portion of the draft part following the heating thereof, the cooling making it possible to freeze the dimensions of the longitudinal portion.

By consolidating, this means decreasing the porosity of the part and ensuring the cohesion of the thermoplastic material.

Preferably, the production device comprises at least one upstream compression member configured to compress the local portion of the draft part against the support member, the upstream compression member being situated upstream of the cooling member. Such a compression member makes it possible to finalise the sizing of the longitudinal portion.

Preferably, the production device comprises at least one downstream compression member configured to compress the local portion of the draft part against the support member, the downstream compression member being situated downstream of the heating member. Such a compression member makes it possible to block the position of the longitudinal portion prior to the heating thereof to avoid any position defect.

Using compression members oriented in different directions in the plane transversal to the longitudinal axis makes it possible to compress the longitudinal portion homogenously by considering the shape thereof. According to an aspect, the production device comprises a plurality of main compression members, in particular, at least one vertical compression member, at least one side compression member and at least one oblique compression member.

Preferably, the production device comprising at least one module comprising a chassis configured to be moved by the movement system, the main compression member is connected to said chassis. Thus, the module is moved longitudinally to consecutively treat each longitudinal portion.

Preferably, the heating member is connected to the chassis of said module, preferably, downstream of said main compression member. This advantageously makes it possible to place the compression member closer to the heating member and to make it possible for a compression of the longitudinal portion when the temperature thereof is increased more in order to reduce the porosity thereof optimally.

Even more preferably, the production device comprising at least one cooling module comprising a chassis configured to be moved by the movement system, the cooling member is connected to said chassis. The cooling module is independent of the heating module so as to be able to configure the cooling kinetics, most suitable for the part to be produced.

Preferably, at least one compression member is connected to said chassis. Thus, the porosity of the longitudinal portion is also reduced during cooling.

According to a preferred aspect, the heating member has a U-shaped section, so as to make it possible for a uniform heating of a local portion of the draft part having a U-shaped section.

Preferably, each compression member comprises at least one rolling member so as to make it possible for a compression during the movement thereof by the movement system.

The invention also relates to a method for producing a structural thermoplastic part, intended to be integrated to a primary structure of an aeroplane, or airplane, from a draft part comprising reinforcing fibres embedded in a thermoplastic matrix, the draft part being supported on a support member extending along a longitudinal axis X, the method comprises:
a step of heating a local portion of the draft part at a temperature making it possible to make the thermoplastic matrix of the draft part melt, then
a step of compressing the local portion of the draft part against the support member so as to decrease the porosity thereof, then
a step of cooling said local portion of the draft part at a temperature making it possible to solidify the thermoplastic matrix of the draft part.

Preferably, each local portion of the draft part is successively heated, compressed and cooled.

### BRIEF DESCRIPTION OF THE DRAWINGS

The invention will be best understood upon reading the following description, given only as an example, and referring to the appended drawings, on which:

FIG. 1 is a schematic representation of a draft part intended to form a structural thermoplastic part of an aeroplane,

FIG. 2 is a schematic, cross-sectional representation of a production device according to an embodiment of the invention,

FIG. 3 is a representation of a production device according to an embodiment of the invention,

FIG. 4 is a longitudinal cross-sectional view of a production device according to an embodiment of the invention,

FIGS. 5 to 7 represent the movement of the modules of the production device from upstream to downstream, on the support member,

FIGS. 8 to 10 have different views of a module comprising a plurality of compression members, and

FIG. 11 is a schematic, perspective representation of a heating member according to an embodiment according to the invention.

It must be noted, that the figures describe the invention in a detailed manner to implement the invention, said figures being able, of course, to be used to best define the invention, if necessary.

### DETAILED DESCRIPTION

In a known manner, a structural thermoplastic part, intended to be integrated to a primary structure of an aeroplane, or airplane, is formed from a draft part comprising reinforcing fibres embedded in a thermoplastic matrix. As indicated above, in order to obtain a finished part, the draft part must be heated at a temperature greater than the melting temperature of the thermoplastic matrix while being compressed in order to increase the density thereof and to stiffen it. As an example, the reinforcing fibres are made of carbon and the matrix is made of PEEK or PEKK.

The draft part 1 has a flexibility which makes it possible for it to mould the shape of the surface which supports it as will be presented below. In a known manner, the draft part 1 is produced by draping reinforcing fibres flat or three-dimensionally. In this example, the draft part 1 is three-dimensional.

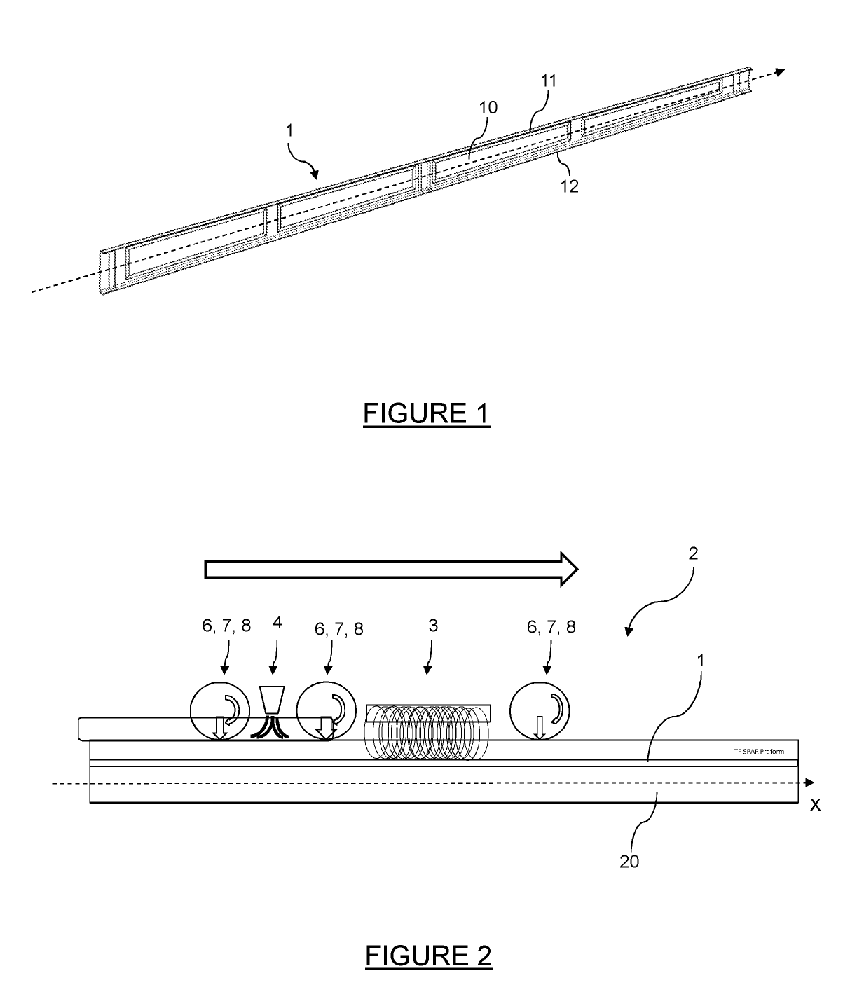

As an example, in reference to FIG. 1, a draft part 1 is represented, which extends longitudinally along an axis over a length greater than 1 m. The draft part 1 has a U-shaped section which varies along the longitudinal axis so as to define a base 10 and two side branches 11, 12. It goes without saying, that the invention is applied to different structural parts, in particular, those which are large, i.e. having at least one dimension greater than 1 m.

In reference to FIG. 2, a device for producing 2 a structural thermoplastic part from a draft part 1 is represented schematically, according to an embodiment of the invention.

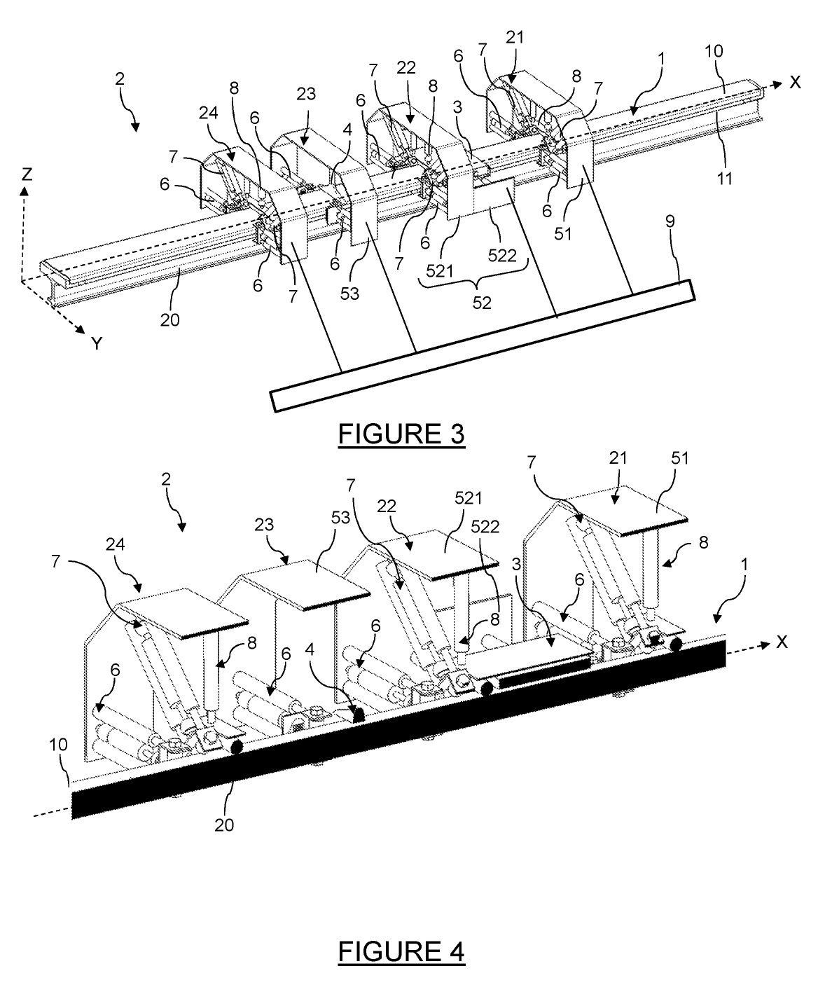

In this example, the production device 2 comprises a member for supporting 20 a draft part 1 which extends from upstream to downstream, a plurality of downstream compression members 6, 7, 8, a heating member 3, a plurality of main compression members 6, 7, 8, a cooling member 4, a plurality of upstream compression members 6, 7, 8 and a movement system 9, represented in FIG. 3, compression members 6, 7, 8, of the heating member 3 and of the cooling member 4 along the longitudinal direction X so as to transform each longitudinal portion of the draft part 1 into a finished longitudinal portion.

In reference to FIGS. 2 and 3, the support member 20 extends along a longitudinal axis X so as to support the draft part 1 along the length thereof. The support member 20 has an upper surface of shape adapted to the finished shape of the structural thermoplastic part. In this example, the support member 20 has a support surface having an inverted U-shaped section. The section of the support surface varies along the length of the support member 20 in order to obtain the desired shape of the structural thermoplastic part.

Subsequently, the production device 2 is defined in an orthogonal marker X, Y, Z wherein the axis X extends longitudinally from upstream to downstream, the axis Y extends laterally from the left to the right, and the axis Z extends vertically from the bottom to the top.

In order to make it possible for an optimal compression of the draft part 1 by the production device 2, the support member 20 has a rigid structure, in particular, made of metal material in order to not be deformed during production. The support member 20 is also called an anvil. In this example, the support member 20 has a length greater than 2 m. It is important that the length of the support member 20 is greater than that of the draft, in particular for reasons of handling and consolidating the material of the draft.

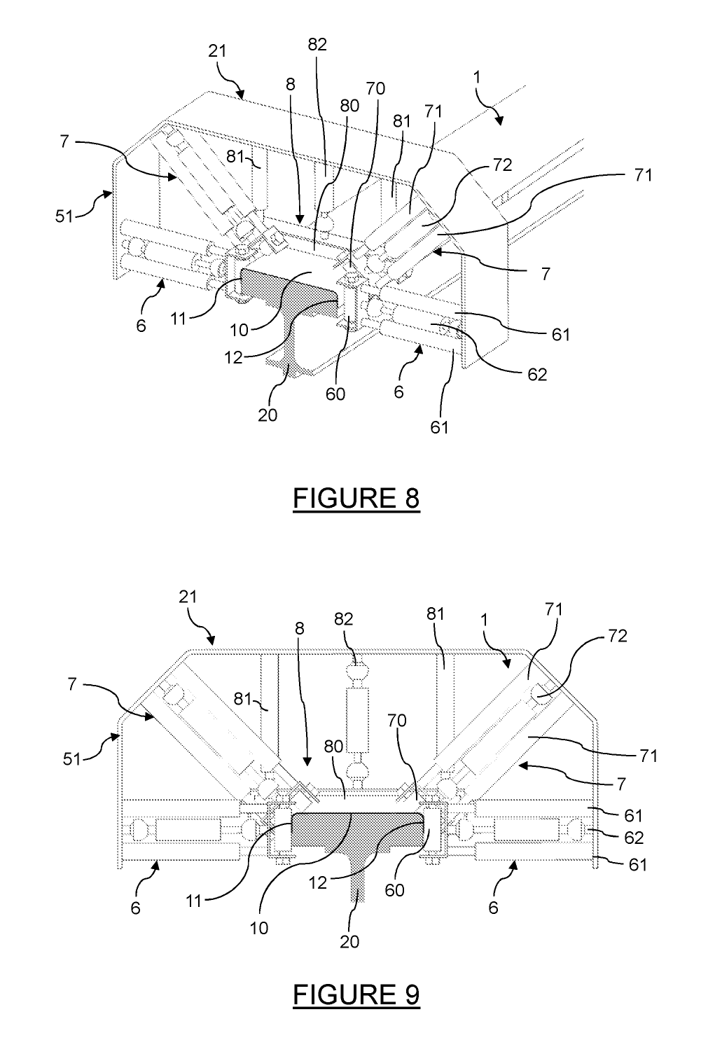

As illustrated in FIGS. 8 to 10, the production device 2 comprises a plurality of compression members 6, 7, 8 to compress a local portion of the draft part 1 against the support member 20. In other words, the local portion of the draft part 1 is spun so as to increase the density thereof and to increase the mechanical resistance of the structural thermoplastic part. The compression members are all oriented in a plane transversal to the axis X so as to successively compress each longitudinal portion.

In this example, each compression member comprises a rolling member, a pressure member to press the rolling member on the draft part and several members for guiding the rolling member. Preferably, the rolling member is presented in the form of a roller and the pressure member is presented in the form of a pressure actuator. The guiding members are themselves presented in the form of wings so as to enable a movement of the rolling member, only in translation along the axis of the pressure member without rotating about said axis. Thus, the compression member can compress the draft part 1 while being moved longitudinally along the axis X on the draft part 1.

In reference to FIGS. 8 and 9, three types of compression members are distinguished: a vertical compression member 8, a side compression member 6 and an oblique compression member 7. Each compression member produces a compression in a plane transversal to the longitudinal axis X so as to successively compress each longitudinal portion of the draft part 1.

As illustrated in FIGS. 8 and 9, a vertical compression member 8 is configured to exert a vertical compression towards the bottom along the axis Z on the base 10 of the draft part 1. To this end, the length of the rolling member 80 of the vertical compression member 8 is greater than the side length of the base 10 of the draft part 1 so as to make it possible for a complete compression. Preferably, the vertical pressure is of between 50 and 300 psi.

Likewise, a side compression member 6 is configured to exert a side compression along the axis Y on a side branch 11, 12 of the draft part 1. To this end, the length of the rolling member 60 of the side compression member 6 is greater than the maximum length of the side branch 11, 12 of the draft part 1 so as to make it possible for a complete compression. Preferably, the side pressure is of between 50 and 300 psi.

Finally, an oblique compression member 7 is configured to exert an oblique compression along an oblique axis with respect to the axes Y and Z at the junction between the base 10 and the branches 11, 12 of the draft part 1. In this example, each oblique compression member 7 extends at 45 from the vertical axis Z and from the side axis Y. The oblique compression member 7 makes it possible for a homogenous compression of the curve of a draft part 1. Preferably, the oblique pressure is of between 50 and 300 psi.

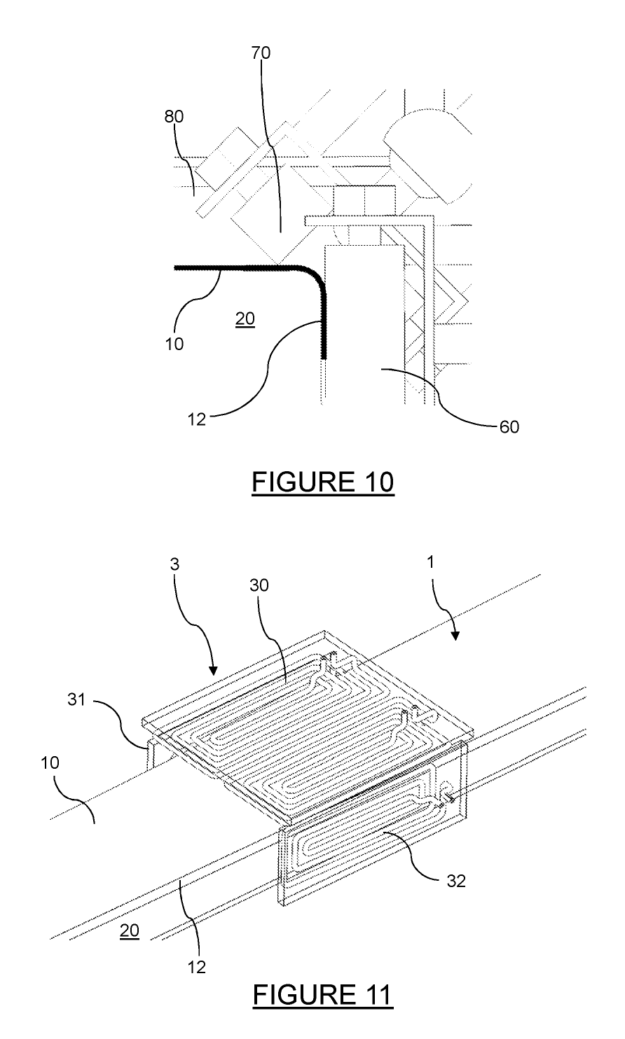

As illustrated in FIG. 10, using a plurality of compression members 6, 7, 8 makes it possible for the rolling members 60, 70, 80 to enter into contact with the whole surface of the draft part 1 to compress it homogenously and uniformly.

As will be presented below, several compression members are assembled in modules to make it possible for a vertical, side or oblique compression at different longitudinal positions so as to make it possible for an optimal transformation of a draft part 1 into a finished part.

Subsequently, a compression member is also characterised according to the position thereof with respect to the heating member 3 and to the cooling member 4. A compression member positioned between the heating member 3 and the cooling member 4 is designated main compression member. A compression member positioned downstream from the heating member 3 is designated downstream compression member, while a compression member positioned upstream of the cooling member 4 is designated upstream compression member.

It goes without saying, that the number and the size of the compression members 6, 7, 8 could increase according to the needs, in particular, to increase the heat exchange surface area.

In reference to FIG. 11, the heating member 3 is configured to heat a local portion of the draft part 1 at a temperature making it possible to make the thermoplastic matrix of the draft part 1 melt. In particular, the heating member 3 makes it possible to heat at a temperature greater than 300° C., preferably 360° C.-380° C., to reach the melting temperature of the thermoplastic matrix of the draft part 1.

The heating member 3 is configured to achieve a heating by induction, but it goes without saying that other heating technologies could suit, in particular, infrared or resistive technologies. In this example, the heating member 3 makes it possible to induce a current in the reinforcing fibres of the draft part 1.

As illustrated in FIG. 11, the heating member 3 has an inverted U-shaped section, so as to be adapted to the shape of the draft part 1. Thus, the base 10 and the side branches 11, 12 of the draft part 1 can be heated homogenously. The heating member 3 comprises an upper wall 30 and two side walls 31, 32, each comprising magnetic spires. Thus, when a longitudinal portion of the draft part 1 is situated in the U-shaped cavity of which the heating member 1 has the shape, the longitudinal portion is heated locally at a high temperature and becomes malleable, which makes it possible for an optimal compression by the compression members 6, 7, 8 as will be presented below.

It goes without saying, that the structure of the heating member 3 could be different according to the heating technology used, for example, resistive or infrared technology.

Preferably, the heating member 3 can be coupled with one or more members for measuring the temperature in order to control the temperature during production.

In reference to FIG. 3, the cooling member 4 is configured to cool a local portion of the draft part 1. In particular, the cooling member 4 makes it possible to cool the longitudinal portion such that it becomes rigid in order to fix the dimensions thereof. In this example, the cooling member 4 is configured to achieve a cooling, by air blowing, in particular, by air blowing so as to cool the draft part 1 at a temperature less than the vitreous transition temperature of the thermoplastic matrix of the draft part 1. It goes without saying, that other cooling technologies could suit, in particular, a refrigerated roller compression system.

The cooling member 4 is presented in the form of an air ejection conduit oriented vertically towards the bottom, so as to cool the base 10 of the draft part 1, as well as the side branches 11, 12 of the draft part 1. Thus, when a longitudinal portion of the draft part 1 is situated under the cooling member 4, this is cooled locally so as to stiffen and freeze the structure thereof.

According to the invention, in reference to FIG. 3, the production device 2 comprises a system for moving 9 the heating member 3, the compression members 6, 7, 8 and the cooling member 4 along the longitudinal axis X of the support member 20 so as to transform each longitudinal portion of the draft part 1 into a finished portion.

In this example, the movement system 9 comprises different movement members (wheels, rail, etc.) to move the members along the longitudinal axis X with respect to the support member 20. However, it goes without saying, that other means could suit, in particular to an overhead moving gantry. The movement system 9 can be fixed to the ground or up high.

In an embodiment not represented, the movement system could be configured to move the support member, the heating, main compression and cooling members remain fixed. Only a relative movement must be made to make it possible for the consecutive consolidation of each longitudinal portion.

In this embodiment example, the different members are brought together in several modules.

In reference to FIGS. 3 to 7, the production device 2 comprises a first downstream compression module 21, subsequently designated as “downstream module 21”, a second heating and compression module 22, subsequently designated as “heating module 22”, a third cooling and compression module 23, subsequently designated as “cooling module 23”, and a fourth upstream compression module 24, subsequently designated as “upstream module 24”. In this embodiment example, the downstream module 21 and the upstream module 24 are identical. Also, for reasons of clarity and conciseness, only the downstream module 21 will thus be presented.

In reference to FIGS. 8 to 10, a downstream module 21 comprising a chassis 51 which has an inverted U-shape defining a concavity is represented, wherein are mounted:
two side compression members 6 respectively configured to exert a pressure on the branches 11, 12 of the draft part 1,
a vertical compression member 8 configured to exert a pressure on the base 10 of the draft part 1, and
two oblique compression members 7 respectively configured to exert a pressure at the junction of the branches 11, 12 and of the base 10 of the draft part 1.

As illustrated in FIGS. 8 and 9, each compression member 6, 7, 8 comprises a rolling member 60, 70, 80, and a pressure member 62, 72, 82 connecting the rolling member 60, 70, 80 to the chassis 51 and two guiding members 61, 71, 81 connecting the rolling member 60, 70, 80 to the chassis 51, in particular, on either side of the pressure member 62, 72, 82. As indicated above, each rolling member 60, 70, 80 is presented in the form of a roller, each pressure member 62, 72, 82 is presented in the form of an actuator and each guiding member 61, 71, 81 is presented in the form of a wing. The chassis 51 of the downstream module 21 is connected to the movement system 9 in order to make it possible for the movement of the downstream module 21 along the longitudinal direction X. During the longitudinal movement along the axis X, the base 10 and the side branches 11, 12 of the draft part 1 are compressed by the compression members 6, 7, 8 against the support member 20, which makes it possible to increase the density thereof by compressing the fibres and the thermoplastic matrix. The downstream module 21 mainly makes it possible to flatten the draft part 1 in the non-consolidated state against the support member 20.

In reference to FIGS. 3 and 4, a heating module 22 is represented, comprising a chassis 52 comprising a downstream portion 522 on which is fixed the heating member 3 and an upstream portion 521 having an inverted U-shape defining a concavity wherein are mounted:
two side compression members 6 respectively configured to exert a pressure on the branches 11, 12 of the draft part 1,
a vertical compression member 8 configured to exert a pressure on the base 10 of the draft part 1,
two oblique compression members 7 respectively configured to exert a pressure on the junction of the branches 11, 12 and on the base 10 of the draft part 1.

The compression members 6, 7, 8 of the heating module 22 are identical to those of the downstream module 21 and will not be presented again. The compression members 6, 7, 8 of the heating module 22 are main compression members, given that they act directly on a portion of the draft part 1 which has been heated beforehand as will be presented below. Advantageously, the proximity of the rolling members 6, 7, 8 and of the heating member 3 makes it possible to effectively compress a local portion, given that it is in a malleable state.

The compression force of each compression member 6, 7, 8 can advantageously be adjusted individually.

The downstream portion 522 of the chassis 52 comprises two side walls to laterally support the heating member 3 such that the latter can heat the base 10 and the branches 11, 12 of the draft part 1. The side walls of the downstream portion 522 of the chassis 52 are connected to the downstream end of the inverted U-shaped upstream portion 521 as illustrated in FIG. 3. Thus, the main compression step can be carried out directly following the heating.

Similarly to above, the chassis 52 of the heating module 22 is connected to the movement system in order to make it possible to move the heating module 22 along the longitudinal direction X. During the longitudinal movement along the axis X, a local portion of the draft part 1 is heated by the heating member 3 at a temperature greater than the melting temperature of the thermoplastic matrix so as to make the draft part 1 malleable, then directly dimensionally stressed by the main compression members 6, 7, 8 in order to give it the final shape thereof, which makes it possible to increase the density thereof by compressing the fibres and the thermoplastic matrix.

In reference to FIGS. 3 and 4, a cooling module 23 is represented, comprising a chassis 53 having an inverted U-shape, defining a concavity wherein are mounted two side compression members 6, respectively configured to exert a pressure on the branches 11, 12 of the draft part 1 and a cooling member 4 configured to blow air on the base 10 and on the branches 11 and 12 of the draft part 1.

The compression members 6 of the cooling module 23 are identical to those of the downstream module 21 and will not be presented again. The compression members 6 of the cooling module 23 are upstream compression members, given that they act directly on a portion of the draft part 1 which has been cooled beforehand.

Similarly to above, the chassis 53 of the cooling module 23 is connected to the movement system 9 in order to make it possible to move the cooling module 23 along the longitudinal direction X. During the longitudinal movement along the axis X, a local portion of the draft part 1 is cooled by the cooling member 4 at a temperature less than the vitreous transition temperature of the thermoplastic matrix so as to make the draft part 1 rigid and to fix the shape thereof. The distance between the modules 21-24 and the forward speeds thereof can be advantageously adjusted.

An implementation example of a method for producing a structural thermoplastic part, intended to be integrated to a primary structure of an aeroplane, from a draft part 1 comprising reinforcing fibres embedded in a thermoplastic matrix will now be presented.

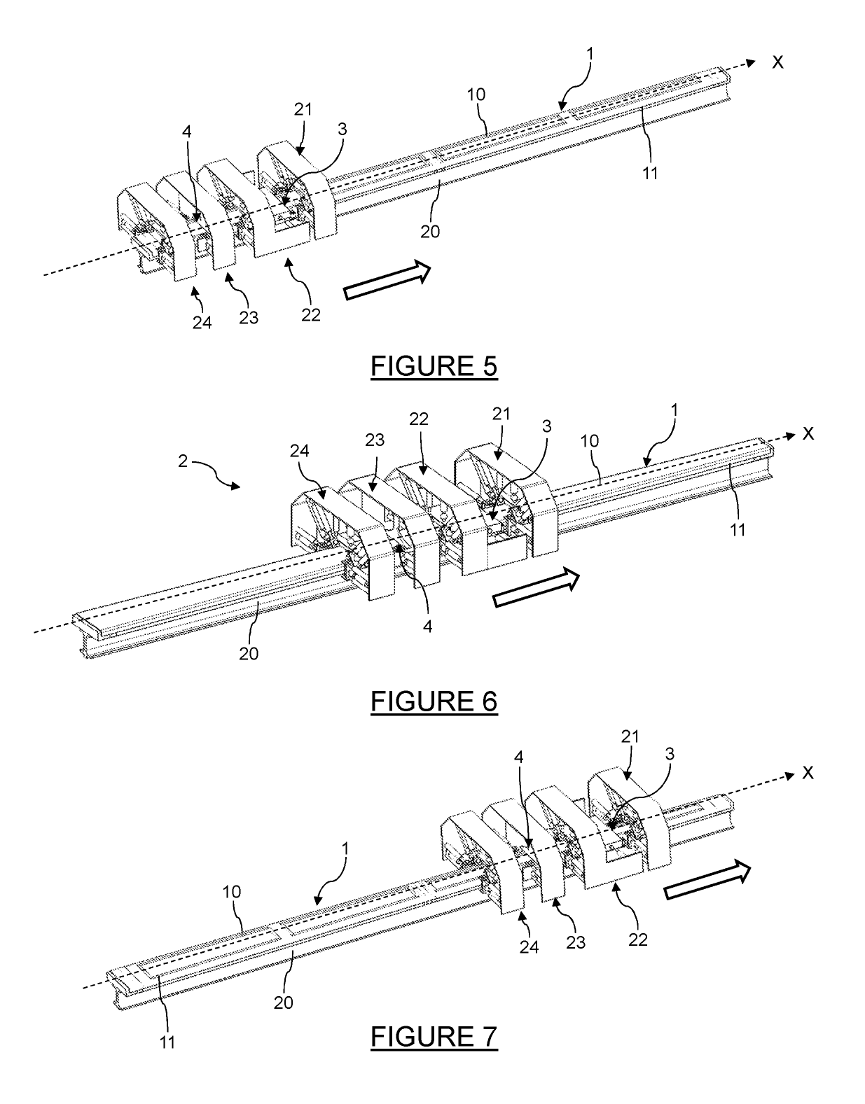

In reference to FIGS. 5 to 7, the draft part 1 is supported on a support member 20 extending along a longitudinal axis X oriented from upstream to downstream.

The modules 21-24 of the production device 2, situated upstream of the draft part 1, are moved continuously or sequentially downwards by the movement system 9 (not represented in these figures).

Each longitudinal portion of the draft part 1 is treated consecutively by the downstream module 21, the heating module 22, the cooling module 23 and the upstream module 24.

The downstream module 21 preliminarily flattens the draft part 1 in its entirety, in order to prepare it for heating. The draft part 1 is thus immobilised.

Then, the heating module 22 heats the local portion of the draft part 1 by induction with the reinforcing fibres at a temperature greater than the melting temperature of the thermoplastic matrix (temperature of around 360° C.-380° C.) in order to soften the draft part 1, then compresses the local portion of the draft part 1 against the support member 20 so as to consolidate it. The integration of compression members 6, 7, 8 and of a heating member 4 in one same heating module 22 advantageously makes it possible for the compression members 6, 7, 8 to optimally deform the draft part 1 which has been made malleable. The heating and compression steps directly follow one another, the thermoplastic matrix not having the time to be cooled at a temperature less than the vitreous transition temperature of the thermoplastic matrix. In other words, the heating module 22 makes it possible to give the local portion a shape closed to the final shape thereof and the reduce the porosity thereof.

The cooling module 23 makes it possible cool the local portion by freezing the thermoplastic matrix, this being cooled at a temperature less than the vitreous transition temperature of the thermoplastic matrix. The integration of side compression members 6 furthermore makes it possible to guide the material during the cooling. Similarly to the downstream module 21, the upstream module 24 compresses and flattens the draft part 1 in order to give it the final shape thereof. Thus, each local portion of the draft part 1 is successively heated, compressed and cooled by the modules 21-24 as illustrated in FIGS. 5 to 7.

Contrarily to a structural part produced with reinforcing fibres embedded in a thermosetting matrix requiring a heating for a long duration at a temperature of between 100° C. and 200° C., a structural part produced with reinforcing fibres embedded in a thermoplastic matrix can be produced by a heating for a short duration at a temperature greater than the melting temperature thereof, which makes it possible to obtain significant production rates.

Furthermore, according to the invention, each longitudinal portion of the draft part 1 can be transformed into a finished portion locally. This is particularly advantageous for producing large parts, it is not necessary to provide an item of equipment such as an autoclave or a press having dimensions greater than the part to be produced. There are thus no longer constraints connected to the dimensions of the part to be produced.

Moreover, contrarily to a previous technique which involved producing a heating and a compression simultaneously, the present invention proposes to produce a compression successively to the heating, which is advantageous.

1. A production device configured to be integrated to a primary structure of an aeroplane, said production device comprising a structural part being formed from a draft part comprising reinforcing fibres embedded in a thermoplastic matrix, the production device comprising:
a member for supporting a draft part, the support member extending along a longitudinal axis,
at least one heating member configured to heat a local portion of the draft part at a temperature making it possible to make the thermoplastic matrix of the draft part malleable,
at least one cooling member configured to cool the local portion of the draft part at a temperature making it possible to solidify the thermoplastic matrix of the draft part,
at least one main compression member configured to compress the local portion of the draft part against the support member so as to decrease the porosity thereof, the main compression member being situated between the heating member and the cooling member, and
a system for moving from upstream to downstream along the longitudinal axis of the heating member, of the compression member and of the cooling member relative to the support member so as to consolidate each local portion of the draft part successively.

2. The production device according to claim 1, comprising at least one upstream compression member configured to compress the local portion of the draft part against the support member, the downstream compression member being situated downstream from the cooling member.

3. The production device according to claim 1, comprising at least one downstream compression member configured to compress the local portion of the draft part against the support member, the upstream compression member being situated upstream from the heating member.

4. The production device according to claim 1, comprising a plurality of main compression members, in particular, at least one vertical compression member, at least one side compression member and at least one oblique compression member.

5. The production device according to claim 1, wherein, the device comprising at least one module comprising a chassis configured to be moved by the movement system, the main compression member is connected to said chassis.

6. The production device according to claim 5, wherein, the heating member is connected to the chassis of said module, preferably downstream from said main compression member.

7. The production device according to claim 5, wherein, the heating member is connected to the chassis of said module downstream from said main compression member.

8. The production device according to claim 1, wherein, the device comprising at least one cooling module comprising a chassis configured to be moved by the movement system, the cooling member is connected to said chassis.

9. The production device according to claim 1, wherein, the heating member has a U-shaped section so as to make it possible for a uniform heating of a local portion of the draft part having a U-shaped section.

10. The production device according to claim 1, wherein each compression member comprises at least one rolling member so as to make it possible for a compression during the movement thereof by the movement system.

11. A method for producing a structural thermoplastic part, intended to be integrated to a primary structure of an aeroplane, from a draft part comprising reinforcing fibres embedded in a thermoplastic matrix, the draft part being supported on a support member extending along a longitudinal axis, the method comprises:
a step of heating a local portion of the draft part at a temperature making it possible to make the thermoplastic matrix of the draft part melt, then
a step of compressing the local portion of the draft part against the support member so as to increase the density thereof, then
a step of cooling said local portion of the draft part at a temperature making it possible to solidify the thermoplastic matrix of the draft part.

12. The method according to claim 10, wherein, each local portion of the draft part is successively heated, compressed and cooled.
